(19) United States
(12) Patent Application Publication
(10) Pub. No.: US 2013/0319757 A1
(43) Pub. Date: Dec. 5, 2013

(54) Connector for Connecting a Cable to an Electric Junction Box

(71) Applicant: Jack Kerr, JR., Hearne, TX (US)

(72) Inventor: Jack Kerr, JR., Hearne, TX (US)

(21) Appl. No.: 13/888,418

(22) Filed: May 7, 2013

Related U.S. Application Data
(60) Provisional application No. 61/654,831, filed on Jun. 2, 2012.

(51) Int. Cl. H02G 3/08

(52) U.S. Cl. CPC H02G 3/083
USPC 174/669

(57) ABSTRACT

A connector for connecting a cable to an electrical junction box. The connector includes a continuous flange and a wall extending from the flange. The wall has a lower end attached to the flange and an opposite upper end. A passageway runs substantially parallel to a central axis of the connector. In addition, the connector includes a horizontal tab extending substantially perpendicular from the wall within the passageway. One or more vertical tabs extend vertically from the flange and are capable of hinging inwardly. A cable is inserted within the passageway and retained by the horizontal tab within the connector.

### RELATED APPLICATIONS

This utility application claims the benefit of U.S. Provisional Patent Application Ser. No. 61/654,831 filed Jun. 2, 2012 by Jack R. Kerr which is hereby incorporated by reference.

### BACKGROUND OF THE INVENTION

1. Field of the Invention

This invention relates to connecting devices. Specifically, and not by way of limitation, the present invention relates to a connector for connecting a cable to an electrical junction box.

2. Description of the Related Art

There are connectors for connecting cables to an electrical junction box. The cables are typically non-metallic sheathed cables and must be locked into a knock-out opening in an electrical junction box.

Although there are no known prior art teachings of a solution to deficiencies in existing connectors, a prior art reference that discusses subject matter that bears some relation to matters discussed herein is U.S. Pat. No. 5,693,910 to Gretz (Gretz) Gretz discloses an electrical connector that is inserted into a hole or knock-out of an electrical junction box. As shown in FIG. 2 of Gretz, the connection is a one-piece C-shaped connector having a hollow body of resilient flexible material. The connector has two gripper jaws that are spaced equidistant around a central axis. The connector also includes a notch which is V-shaped and extends through the base flange of the connector. The base flange has a diameter greater than the opening in the panel and is formed of two arcuate parts with each part having a first facing end and a second facing end. The notch works in conjunction with a cutout. The combination action of the notch and the cutout creates a hinge to enable flexing of the connector 20, causing the opposing edges of the cutout to close together.

However, Gretz suffers from several disadvantages. The C-shape is difficult and expensive to manufacture. Furthermore, due to the C-shaped configuration, Gretz merely provides an uneven flexing of the connector.

It would be advantageous to have a connector which enables evenly distributed flexing of the connector and which is inexpensive to manufacture. It is an object of the present invention to provide such an apparatus.

### SUMMARY OF THE INVENTION

In one aspect, the present invention is directed to a connector for connecting a cable to an electrical junction box. The connector includes a continuous flange and a wall extending from the flange. The wall has a lower end attached to the flange and an opposite upper end. A passageway runs substantially parallel to a central axis of the connector. In addition, the connector includes a horizontal tab extending substantially perpendicular from the wall within the passageway. One or more vertical tabs extend vertically from the flange and are capable of hinging inwardly. A cable is inserted within the passageway and retained by the horizontal tab within the connector.

In another aspect, the present invention is directed to a connector and electrical junction combination for connecting a cable to the electrical junction box. The combination includes an electrical junction and a connector. The connector includes a continuous flange and a wall extending from the flange. The wall has a lower end attached to the flange and an opposite upper end. A passageway runs substantially parallel to a central axis of the connector. In addition, the connector includes a horizontal tab extending substantially perpendicular from the wall within the passageway. One or more vertical tabs extend vertically from the flange and are capable of hinging inwardly. A cable is inserted within the passageway and retained by the horizontal tab within the connector.

### BRIEF DESCRIPTION OF THE DRAWINGS

FIG. 1 is a first top view of a one-piece O-shaped connector;

FIG. 2 is a second top view of the connector;

FIG. 3 is a third top view of the connector;

FIG. 4 is a bottom view of the connector of FIG.

FIG. 5 is a side view of the connector of FIG. 1;

FIG. 6A is a side view of the connector;

FIG. 6B is a cross sectional view of FIG. 6A; and

FIG. 7 is a second cross sectional view of the connector.

### DESCRIPTION OF THE INVENTION

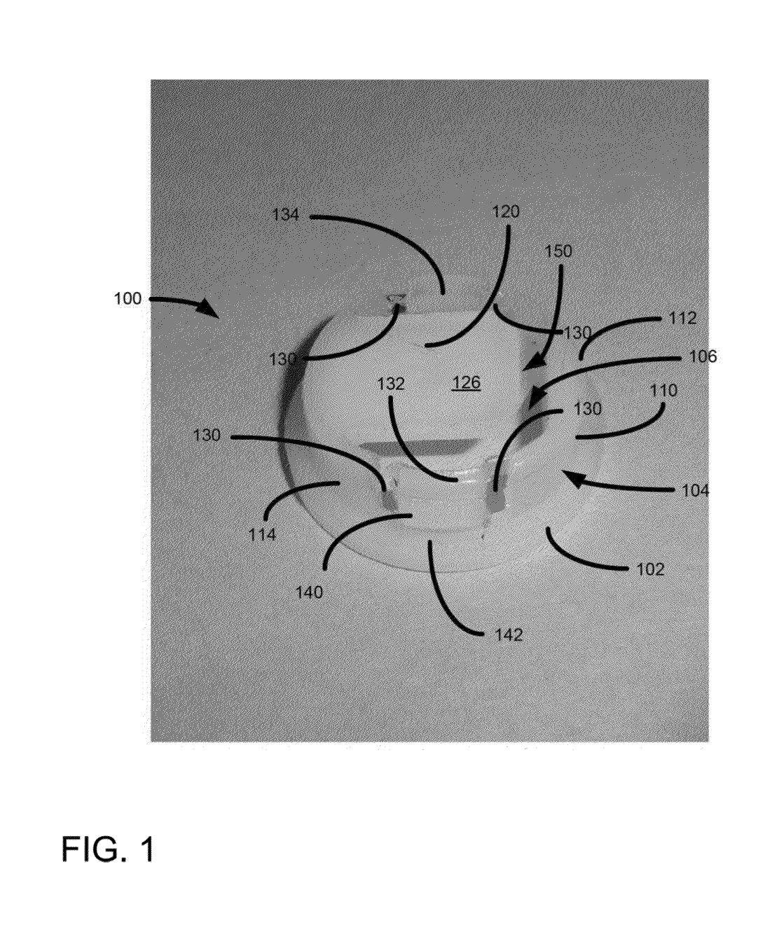

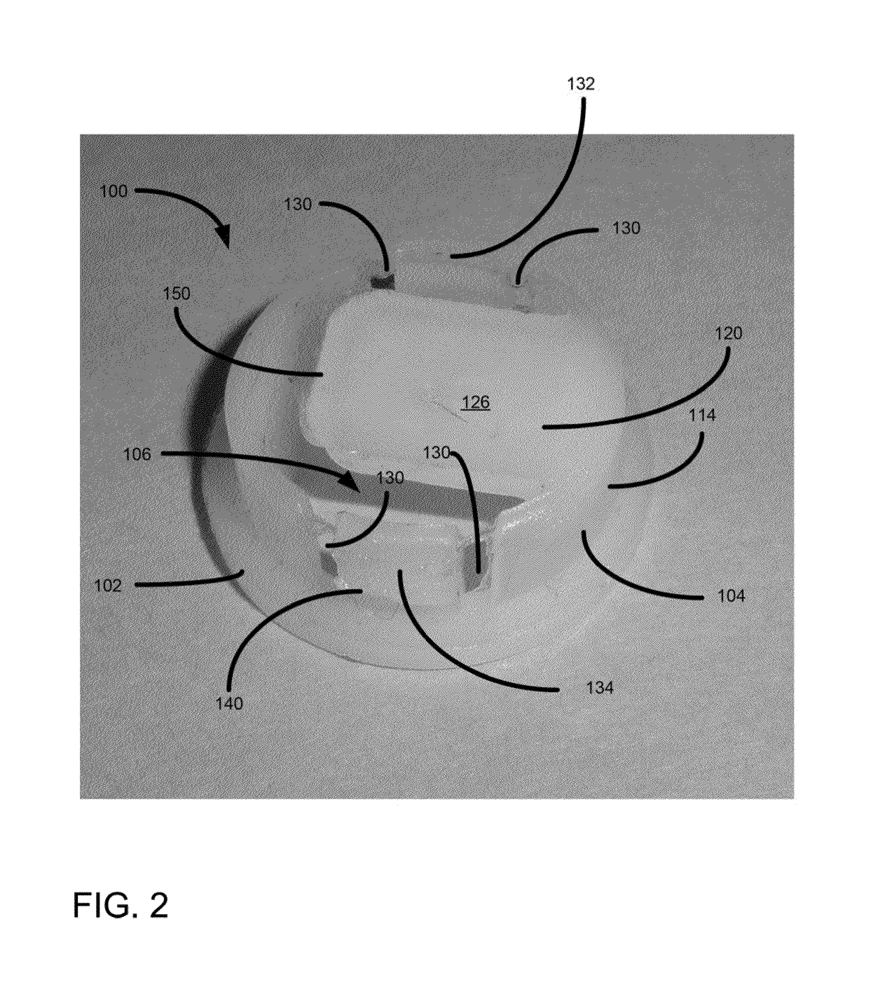

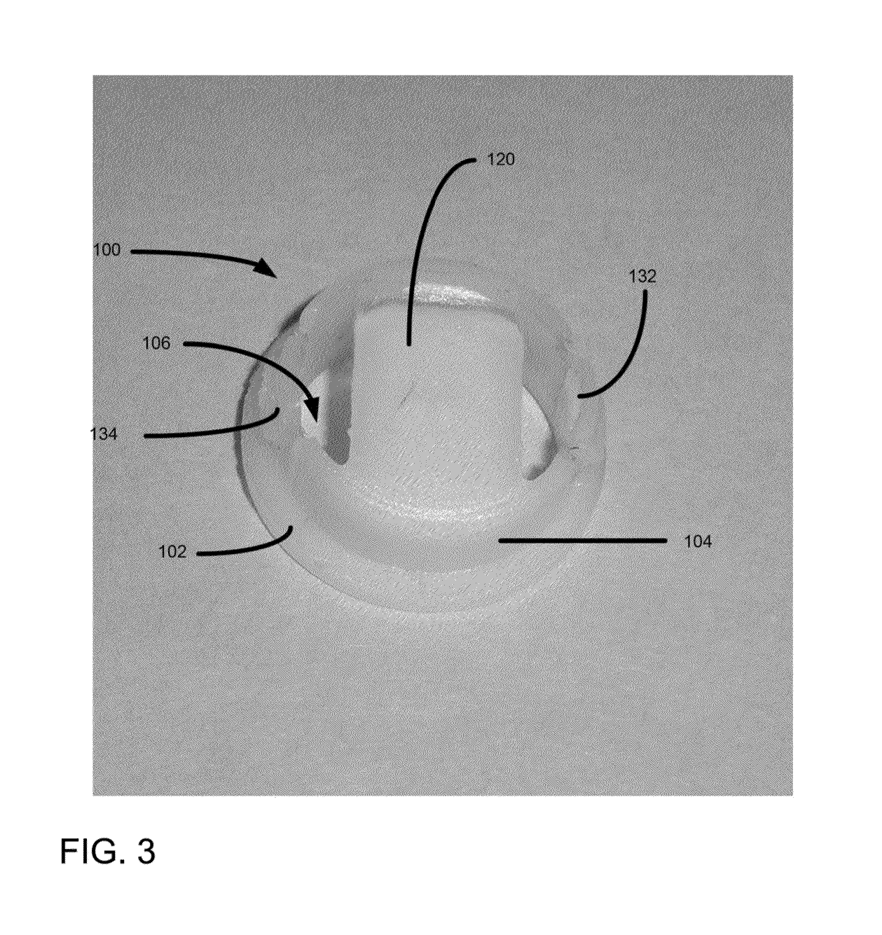

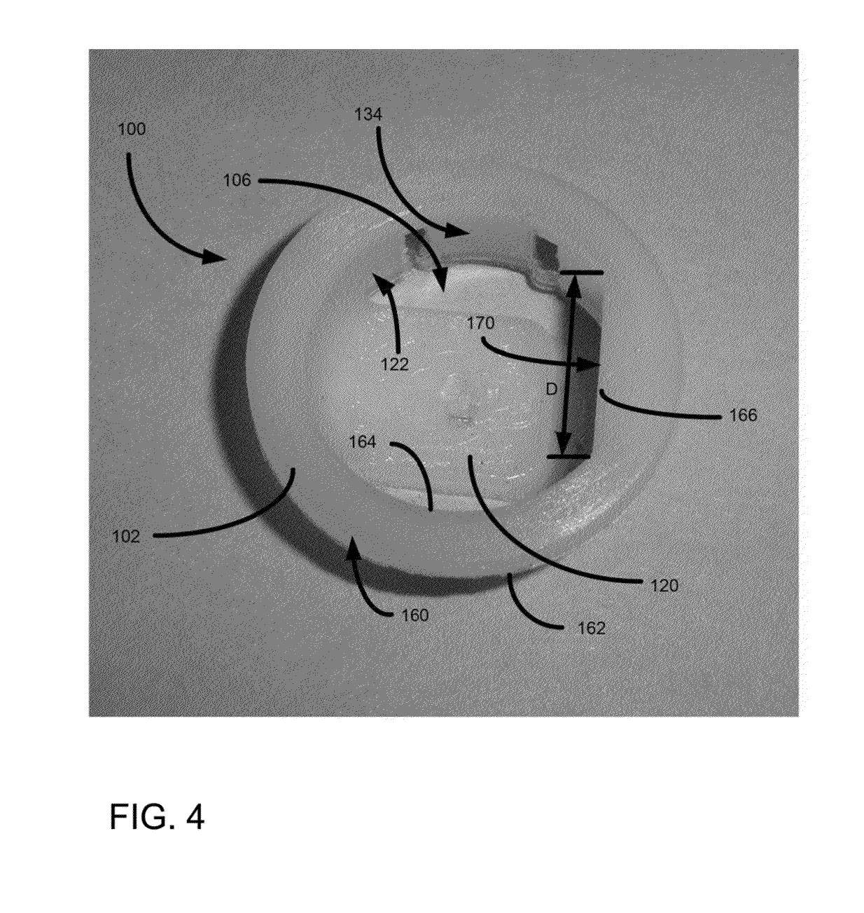

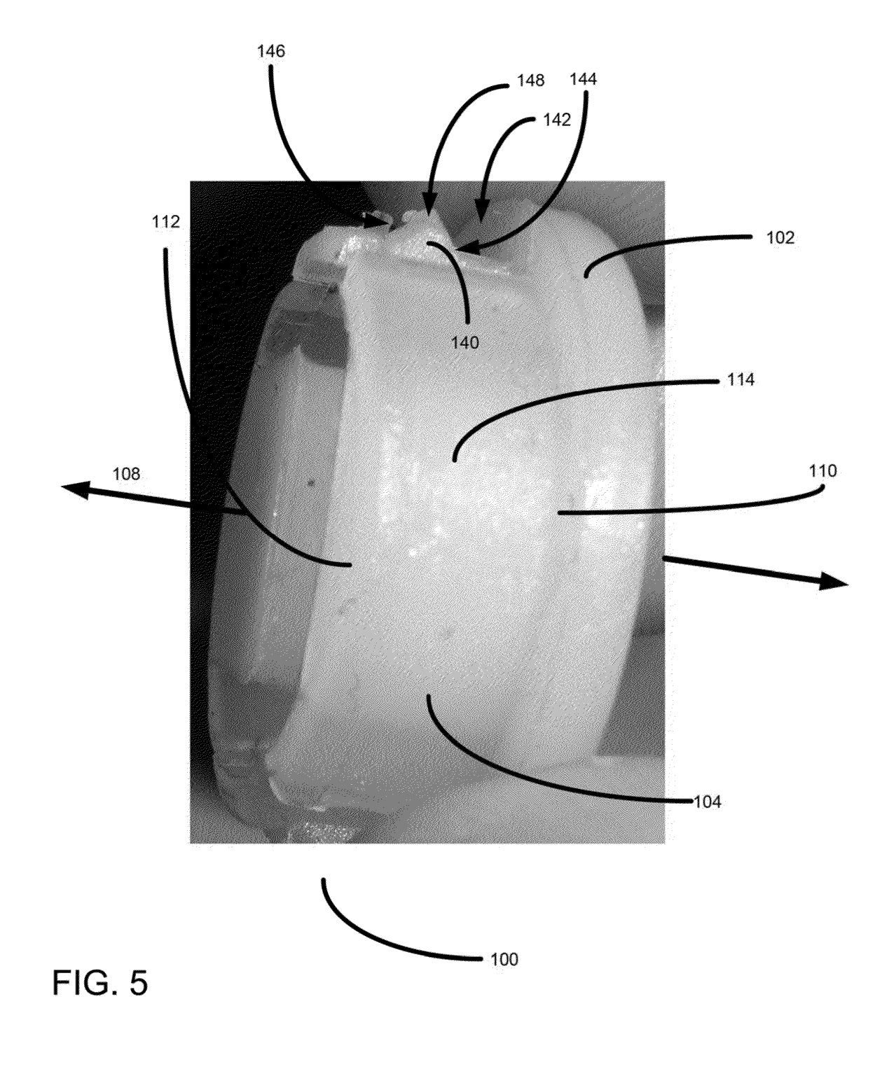

The present invention is a connector for connecting a cable to an electrical junction box. FIG. 1 is a first top view of a one-piece O-shaped connector 100 having a hollow body and fabricated from a flexible, resilient material, such as rubber or plastic. FIG. 2 is a second top view of the connector 100 of FIG. 1. FIG. 3 is a third top view of the connector 100 of FIG. 1. FIG. 4 is a bottom view of the connector 100 of FIG. 1. FIG. 5 is a side view of the connector 100 of FIG. 1. The connector includes a substantially continuous flange 102 and a cylindrical-shaped wall 104. The wall 104 includes a hollow passageway 106 substantially parallel to a central axis 108. The wall has a lower end 110 attached to the flange 102, a second upper end 112 (opposite the flange) and a central portion 114. A tab 120 extends from an inner surface 122 of the upper end 112 of the wall 104 into the hollow passageway 106 such that a surface plane 126 of the tab 120 is substantially perpendicular to the central axis 108.

The wall 104 of the connector 100 has an outer diameter sized to allow insertion of the wall 104 into a standard size knock-out opening for an electrical junction box (not shown). The wall 104 includes partial gaps 130 on each side of vertical tabs 132 and 134. The vertical tabs extend upward from the flange 102 to a position flush with the upper end 112. The vertical tabs are on opposite sides of the passageway 106. Each vertical tab includes a ridge portion 140 and indention 142. The ridge portion enables the connector to securely rest within a knock-out opening of the electrical junction box. The ridge portion 140 includes a lower edge 144, an upper edge 146, and an outer edge 148. The partial gap 130 and vertical tabs 132 and 134 allow the wall 104 to hinge inwardly, and upon clearance of the wall of the electrical box, snap back so as to return to a position perpendicular to the flange 102 and parallel to the central axis 108. This motion and position after clearance of the ridge portions 140 “locks” the connector 100 in position on an electrical box. As depicted in FIG. 1 from a top view, the tab 120 is horizontally oriented while the tabs 132 and 134 are vertically oriented. However, it should be understood that the tab 120 and tabs 132 and 134 may be orientated in any position and the naming of the tabs as vertical and horizontal is for orientation and reference purpose only. Additionally, although two vertical tabs are illustrated, the present invention may use one or more vertical tabs and still remain in the scope of the present invention.

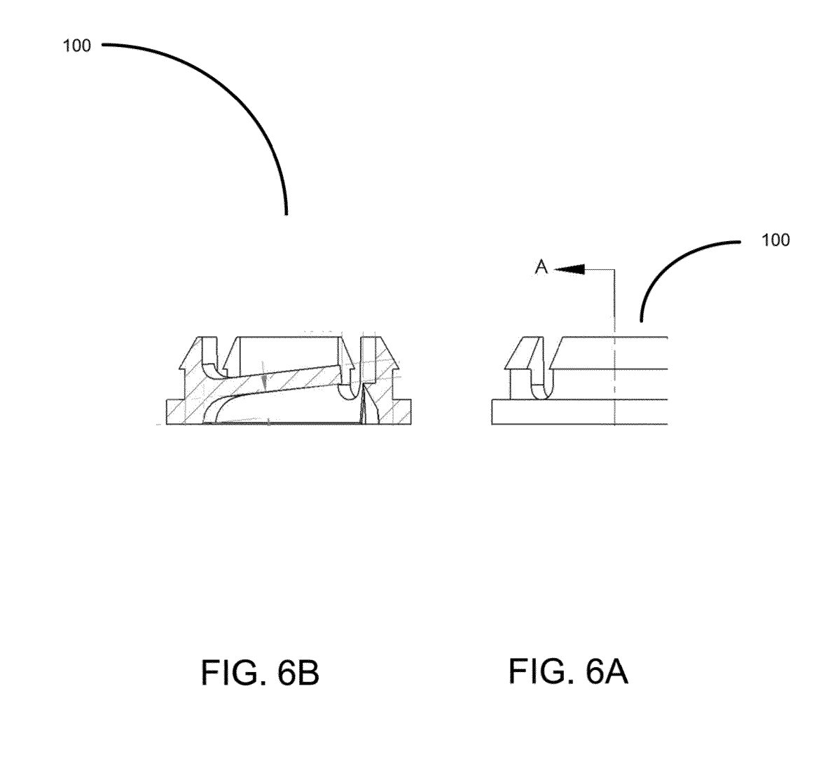

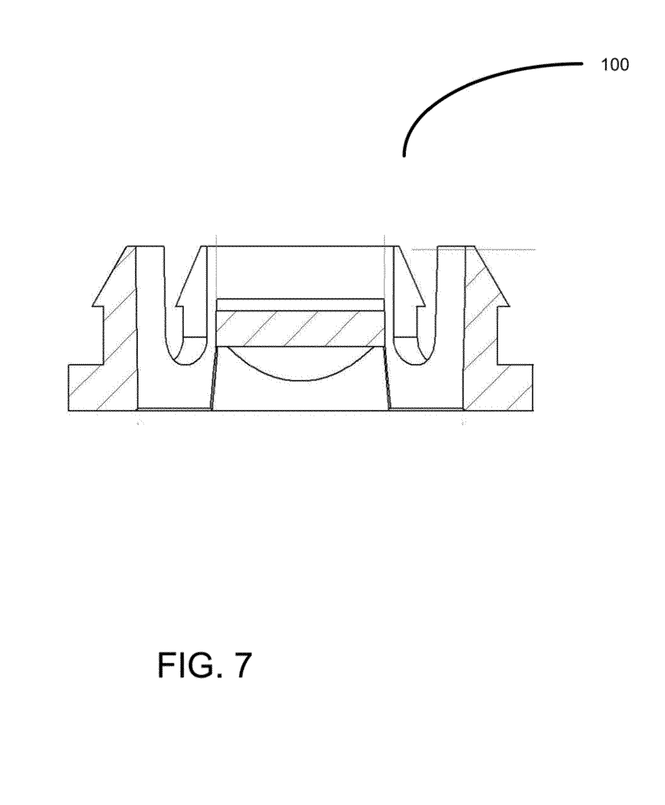

Referring to FIG. 4, the connector includes a bottom rim 160 located on the flange 102 having an outer border 162 and an inner border 164. The bottom rim includes a substantially circular shape for the outer border 162. However, the inner border includes a straight edge 166 having a length D which runs upward adjacent the upper end 112 of the wall forming an inner planar surface 170 of the inner surface 122 of wall 104 and flange 102. FIG. 6A is a side view of the connector 100. FIG. 6B is a cross sectional view of FIG. 6A. FIG. 7 is a second cross sectional view of the connector 100.

With reference to FIGS. 1-5, the operation of the connector 100 will now be explained. The connector is inserted with a knock-out opening of an electrical junction box (not shown). The vertical tabs 132 and 134 are flexed inwardly to allow the outer edge 148 of the ridge portion to pass through the knock-out opening of the electrical box junction. After passing through the opening, the vertical tabs return to their original vertical position with the lower edge of the ridge portion positioned adjacent the opening of the electrical junction box. A rim of the opening rests within the indention 142 on the vertical tabs. The connector includes the flange 102 which is larger than the opening of the electrical junction box. Thus, the connector is securely attached to the electrical junction box. A cable, preferably a sheathed cable (not shown), is inserted with the passageway 106 of the connector. The cable is then retained in a desired position by the tab 120 where an outer periphery 150 of the tab contacts the cable. The present invention is a connector which enables even flexing and which is inexpensive to manufacture

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A connector for connecting a cable to an electrical junction box, the connector comprising:
a continuous flange;
a wall extending from the flange, the wall having a lower end attached to the flange and an opposite upper end;
a passageway running substantially parallel to a central axis of the connector;
a horizontal tab extending substantially perpendicular from the within the passageway;
a first vertical tab extending vertically from the flange;
wherein the first vertical tab is hinged inwardly;
whereby a cable is inserted within the passageway and retained by the horizontal tab.

2. The connector according to claim 1 further comprising a second vertical tab extending vertically from the flange.

3. The connector according to claim 2 wherein the second vertical tab is positioned on an opposite side of a passageway from the first vertical tab.

4. The connector according to claim 2 wherein the first vertical and second tabs each include a ridge portion and an indentation, the ridge portion and indention for retaining the connector against an electrical box junction.

5. The connector according to claim 1 wherein the first vertical tab includes a ridge portion and an indentation, the ridge portion and indention for retaining the connector against an electrical box junction.

6. The connector according to claim 1 wherein the wail is cylindrically-shaped.

7. The connector according to claim 1 wherein an outer diameter of the wall is sized and shaped to be inserted within an electrical junction box.

8. The connector according to claim 1 wherein the passageway include a portion having a straight edge.

9. The connector according to claim 1 wherein the first vertical tab includes partial gaps on each side of the vertical tab to allow the first vertical tab to hinge inwardly.

10. A connector and electrical junction combination for connecting a cable to the electrical junction box, the combination comprising:
an electrical junction; and
a connector, the connector comprising:
a continuous flange;
a wall extending from the flange, the wall having a lower end attached to the flange and an opposite upper end;
a passageway running substantially parallel to a central axis of the connector;
a horizontal tab extending substantially perpendicular from the wall within the passageway;
a first vertical tab extending vertically from the flange;
wherein the first vertical tab is hinged inwardly;
whereby a cable is inserted within the passageway and retained by the horizontal tab.

11. The combination according to claim 10 further comprising a second vertical tab extending vertically from the flange of the connector.

12. The combination according to claim 11 wherein the second vertical tab is positioned on an opposite side of a passageway from the first vertical tab.

13. The combination according to claim 11 wherein the first vertical and second tabs each include a ridge portion and an indentation, the ridge portion and indention for retaining the connector against an electrical box junction.

14. The combination according to claim 10 wherein the first vertical tab includes a ridge portion and an indentation, the ridge portion and indention for retaining the connector against an electrical box junction.

15. The combination according to claim 10 wherein an outer diameter of the wall of the connector is sized and shaped to be inserted within an electrical junction box.

16. The combination according to claim 10 wherein the passageway include a portion having a straight edge.

17. The combination according to claim 10 wherein the first vertical tab includes partial gaps on each side of the vertical tab to allow the first vertical tab to hinge inwardly.

18. A connector for connecting a cable to an electrical junction box, the connector comprising:
a continuous flange;
a cylindrically-shaped wall extending from the flange, the wall having a lower end attached to the flange and an opposite upper end;
a passageway running substantially parallel to a central axis of the connector;
a horizontal tab extending substantially perpendicular from the wall thin the passageway;
a first vertical tab extending vertically from the flange;
a second vertical tab extending vertical from an opposite side of the flange from the first vertical tab;
wherein the first vertical tab is hinged inwardly;
whereby a cable is inserted within the passageway and retained by the horizontal tab.
